(19) United States
(12) Patent Application Publication
(10) Pub. No.: US 2008/0165666 A1
(43) Pub. Date: Jul. 10, 2008

(54) CONTINUOUS ADDRESSING MULTI-LAYER OPTICAL DISK AND ADDRESSING METHOD THEREOF

(75) Inventor: Hong-Zeng Yeh, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/754,271

(22) Filed: May 26, 2007

(30) Foreign Application Priority Data
Jan. 5, 2007 (TW) 96100459

(51) Int. Cl. G11B 7/24

(52) U.S. Cl. 369/275.1; 369/283

(57) ABSTRACT

A continuous addressing optical disk including a plurality of recording layers is provided. Wherein, the N^{th} recording layer has a plurality of data sectors with continuous addresses. The (N+1)^{th} recording layer has a plurality of data sectors with continuous addresses. Wherein, the addresses of the data sectors of the N^{th} and (N+1)^{th} recording layers are continuous. The present invention will not waste the addressing space for multi-layer optical disk because the addresses of data sectors of adjoining recording layers are continuous.

### CROSS-REFERENCE TO RELATED APPLICATION

This application claims the priority benefit of Taiwan application serial no. 96100459, filed on Jan. 5, 2007. All disclosure of the Taiwan application is incorporated herein by reference.

### BACKGROUND OF THE INVENTION

1. Field of the Invention

The present invention generally relates to a data addressing of a multi-layer disk, and more particularly, to a continuous addressing technology for a plurality of recording layers capable of not wasting addressing space.

2. Description of Related Art

Nowadays, a DVD-ROM disk with single surface and dual layers has two types: a parallel track path (PTP) and an opposite track path (OTP). FIG. 1 is view illustrating the method for addressing of a conventional PTP type of disk. Referring to FIG. 1, the PTP type of disk may be viewed as two independent layers, wherein the first layer and the second layer have lead-in zones and lead-out zones, respectively. In the conventional PTP type of disk, the reading directions of the first layer and the second layer are all from inner radius to outer radius. The addressing method may be adapted for the addressing of a multi-layer disk because each layer has the independent lead-in zone and lead-out zone. However, if continuous data are disposed at the joint of different layers (for example, the first layer and the second layer), the PTP addressing method may not be adapted for the disk. A servo system must move an optical pickup head from the outer radius of the first layer to the inner circle of the second layer and perform servo routine. (additionally, the reading time for the lead-in zone of the second layer also must be considered) There are strict requirements on the performances of the sever system.

FIG. 2 is a view illustrating the method for reading data and addressing of a conventional OTP disk. Referring to FIG. 2, because the data of adjoining two layers of the conventional OTP disk is continuous and integral, the disk has only one set of lead-in zone and lead-out zone. Corresponding to a PTP disk, when the servo system reads the continuous data at the joint of the first layer and the second layer of the conventional OTP disk, the servo system only performs a jumping layer and a refocusing operation. It has not to move the optical pickup head at a large range, such that it will not waste lots of time. The method for the conventional OTP addressing has two important factors to be considered: First, each physical sector number address (PSN address) is unique. Second, the PSN address of each layer must be easily convertible to the PSN address of the first layer by a simply converted calculation (i.e., providing a reference position to the servo system, the reference position may be used as a reference index of jumping track and positioning of the layer). On the design of the conventional OTP disk, the PSN addresses of the second layer use the inverted values of the PSN addresses of the first layer according to the above-said factors.

FIG. 3 is a schematic view illustrating the addressing space of the conventional OTP. As shown in FIG. 3, the method makes it easy to switch between the PSN addresses of the first layer and those of the second layer. In another word, there are complementary results between the addresses of the first layer and the second layer. For example, the PSN address of the sector X of the first layer in FIG. 3 is 035100h, thus the PSN address of the corresponding position of the second layer is FCAEFFh. Thus, after the servo system can perform inverted calculation according to the PSN address of the sector of the first layer, the PSN address of the corresponding position of the second layer can be obtained.

However, because the PSN addresses use inverted values in the conventional OTP addressing method, a part of the PSN addresses will not be used. As shown in FIG. 3, the PSN addresses from the middle zone of the first layer to 7FFFFFh will not be used. Correspondingly, the PSN addresses from 800000h to the middle zone of the second layer will not be used. So the conventional OTP addressing method will waste the addressing space of the PSN address.

In addition, if the conventional OTP addressing method is adapted for a multi-layer disk, other judgment factors should be added. For example, a flag bit is used to judge the number of the layer. FIG. 4 is a schematic view illustrating the addressing method for the OTP disk with single surface and four layers of U.S. Pat. No. 5,881,032. The patent introduces the reading and addressing methods for the OTP disk with single surface and dual layers and the OTP disk with single surface and four layers. For the disk that has two recording layers on the same surface, the reading method of the first layer is that reading data is from inner radius to outer radius. The reading method of the second layer is contrary to that of the first layer to form an opposite situation. The methods of the two layers are all constant linear velocity (CLV). Referring to FIG. 4, the disk has a first layer, a second layer, a third layer and a fourth layer. Between the third layer and the fourth layer, for the PSN address, the high flag bit must be added to judge the number of the layer. As shown in FIG. 4, 1000000h must be added in the PSN address, it corresponds to add a high bit flag. The more layers in the disk, the more flag bits will be. So it increases complexity and wastes recording field.

As described above, the addressing method for the PTP disk is adapted for a multi-layer disk but is not adapted to record continuous data. The addressing method for the OTP disk is adapted to record continuous data, but the number of the recording layers should not be too many and the method wastes the addressing space of the PSN address. Because of the problems of the various conventional addressing methods, the present invention provides an addressing method that can records continuous data and be adapted for a multi-layer disk.

### SUMMARY OF THE INVENTION

Accordingly, the present invention provides a continuous addressing multi-layer optical disk and addressing method thereof, the PSN addresses of a plurality of recording layers may be continuous by using the continuous addressing method, such that the addressing space will not be wasted.

The present invention provides a continuous addressing multi-layer optical disk. Each recording layer respectively has a plurality of sectors and divides the sectors into at least a user region and at least a control region, wherein each sector has a PSN address and a region type. The PSN addresses of the sectors in the N^{th} recording layer are continuous, and the PSN addresses of the sectors in the (N+1)^{th} recording layer are continuous, wherein the PSN addresses of the user region in the N^{th} recording layer and the user sector in the (N+1)^{th} recording layer are continuous, wherein the PSN address may be replaced by a form of anyone type of basic address unit.

The present invention may be adapted for a plurality of recording layers and will not waste the addressing space because the addresses of data sectors of adjoining recording layers are continuous.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a view illustrating a method for reading data and addressing of the conventional PTP disk.

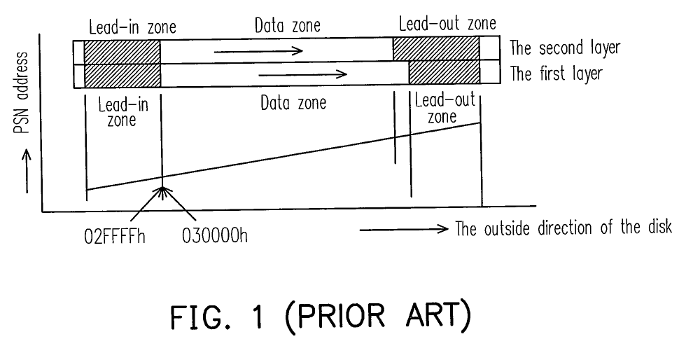

FIG. 2 is a view illustrating a method for reading data and addressing of a conventional OTP disk.

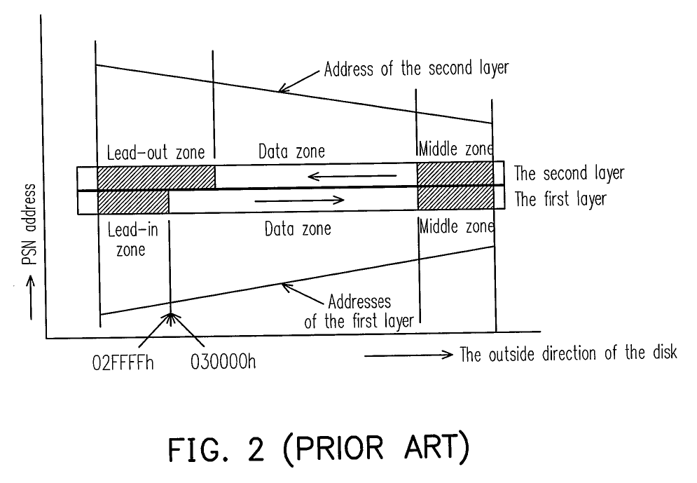

FIG. 3 is a schematic view illustrating an addressing space of a conventional OTP.

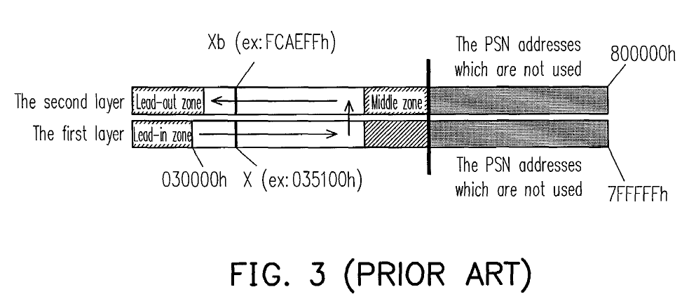

FIG. 4 is a schematic view illustrating an addressing method for the OTP disk with single surface and four layers of U.S. Pat. No. 5,881,032.

FIG. 5 is a view illustrating an exemplary embodiment of addressing of a disk with single surface and dual layers according the present invention.

FIG. 6 is a view illustrating an exemplary embodiment of the data structure of a sector according the present invention.

FIG. 7 is a view illustrating an exemplary embodiment of the addressing of a disk with single surface and three layers according the present invention.

FIG. 8 is a view illustrating an exemplary embodiment of the addressing of a disk with single surface and four layers according the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to easily understand the following embodiments, the cross-reference list (as shown in list.1) of the special terms of DVD-ROM and the special terms of the present invention is provided. However, List.1 only provides the reference examples, and the present invention will not be limited to these.

| the special terms of | the special terms of |
|---|---|
| DVD-ROMs | the present invention |
| Lead-in Zone | Guide-in Region |
| Lead-out Zone | Guide-out Region |
| Data Zone | User Region |
| Middle Zone | Jump Region |
| List.1 | |

The continuous addressing optical disk of the present invention has a plurality of recording layers, and the sectors are divided into at least a user region and at least a control region, wherein each sector has a PSN address and a region type. The PSN addresses of the sectors in the N^{th} recording layer are continuous, and the PSN addresses of the sectors in the (N+1)^{th} recording layer are continuous, wherein the PSN addresses of the user region in the N^{th} recording layer and the user sector in the (N+1)^{th} recording layer are continuous. Additionally, the PSN address may be replaced by anyone type of basic address unit. The above control region may be a guide-in region, a guide-out region or a jump region. The continuous addressing method of the present invention will be illustrated according to the disk with single surface and dual layers.

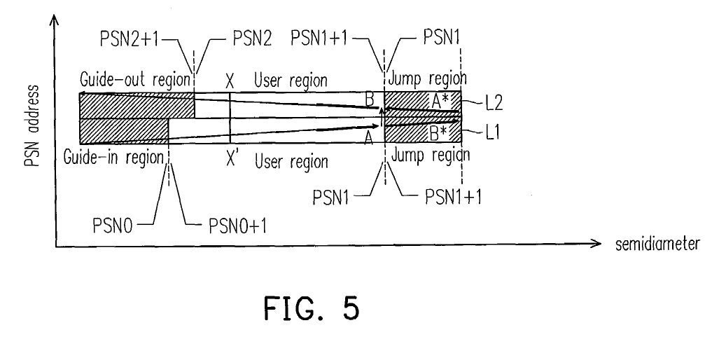

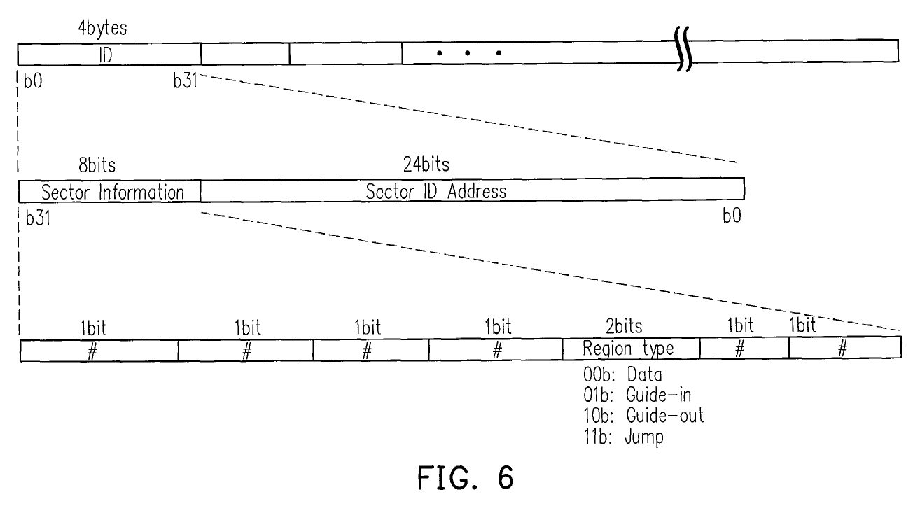

FIG. 5 is a view illustrating an exemplary embodiment of the addressing of a disk with single surface and dual layers according the present invention. The optical disk includes recording layers L1 and L2. The recording layers L1 and L2 have data tracks, respectively. The data track is formed of lots of sectors, each sector has a recording address. As shown in FIG. 6, in the exemplary embodiment, each sector respectively has a functional field, such as an ID field and the like, wherein the ID field comprises a sector information and a sector address. The ID field has 4 bytes, wherein the sector information has 8 bits, and the sector address has 24 bits. Two bits of the 8 bits of the sector information record the region type. For example, the region type of each sector in the guide-in region may be [01] to indicate that the region is a guide-in region, and the region type of each sector in the user region may be [00] to indicate that the region is a user region, the region type of each sector in the jump region may be [11] to indicate that the region is a jump region or the region type of each sector in the guide-out region may be [10] to indicate that the region is a guide-out region.

In the exemplary embodiment, the reading method of the recording layer L1 is that reading data is from its inner radius to the outer radius, and the reading method of the recording layer L2 is contrary to that of the recording layer L1. In addition, the PSN addresses of the recording layer L1 increase from its inner radius to its outer radius; however, the PSN addresses of the recording layer L2 increase from its outer radius to its inner radius. In other exemplary embodiments, the reading method of the recording layer L1 may be that reading data is from its outer radius to its inner radius, and the reading method of the recording layer L2 is that reading data is from its inner radius to its outer radius. According to the present invention, the PSN addresses of the recording layer L1 may increase from its outer radius to its inner radius, however, the PSN addresses of the recording layer L2 may increase from its inner radius to its outer radius.

Again returning to FIG. 5, the recording layer L1 has the guide-in region, the user region and the jump region, each region respectively has a plurality of sectors. The continuous numbers from PSN0+1(for example, 020000h) to PSN1 may be used as the PSN addresses of a plurality of data sectors in the user region. The above-said PSN1 is an integral number which is larger than the PSN0. These data sectors may be used to record the data of the user. In the example embodiment, the addresses of all sectors in the guide-in region, the user region and the jump region are continuous. For example, if the last PSN address of the guide-in region is PSN0 (e.g., 01FFFFh), the PSN address of the user region may begin addressing at PSN0+1. If the PSN address of the last data sector of the user region is PSN1, the PSN address of the jump region may begin addressing at PSN1+1.

Because of the optical disk with single surface and dual layers as shown in FIG. 5, the recording layer L2 has the jump region, the user region and guide-out region. The above-said regions respectively have a plurality of sectors. The address of each sector in the jump region, the user region and the guide-out region of the recording layer L2 is also continuous. For example, if the PSN address of the last data sector of the jump region is PSN1, the PSN address of the user region begins addressing at PSN1+1. If the PSN address of the user region is PSN2, the PSN address of the guide-out region may begin addressing at PSN2+1. The above-said PSN2 is an integral number which is larger than PSN1. It is noted that the PSN addresses of the data sectors of the user region in the recording layer L1 and the data sectors of the user region in the recording layer L2 are also continuous. For example, if the PSN address of the last data sector of the user region in the recording layer L1 is PSN1, the PSN address of the last data sector of the user region in the recording layer L2 may begin addressing at PSN1+1.

According to the above-said, the user region and the jump region of the recording layer L1 use the recording method with continuous PSN addresses, the jump region and the user region of the recording layer L2 use the recording method with continuous PSN addresses, and the user region of the recording layer L1 and the user region of the recording layer L2 also use the recording method with continuous PSN addresses. Thus, a part of the PSN addresses of the user region will be overlapped over the jump region. As shown in FIG. 5, the regions of the mark A and the mark A* represent their PSN addresses to be repeated, and the regions of the mark B and the mark B* represent their PSN addresses to be repeated. In the embodiment, the region type in the ID field of FIG. 6 may be used as identification. Each sector has an ID field. Making use of the region type in the ID field can identify that the sector is a user region or a jump region. For example, in the PSN addresses to be repeated of the mark A and the mark A* of FIG. 5, if the region type of the sector is 11b, it indicates that the position which is being read by the optical pickup is the A* region (the jump region).

During recording data, when connecting the jump region after the last data sector of the user region, recording of the data is continued by using the method for increasing the PSN addresses (as shown in the jump region of the recording layer L1 of FIG. 5). When connecting the jump region before the first data sector of the user region, the recording of the data continued by using the method for decreasing the PSN addresses (as shown in the jump region of the recording layer L2 of FIG. 5), such that the requirement which the PSN addresses of the single layer may be continuously recorded can be achieved.

Thus, the end position of the user region of the recording layer L1 (i.e., the sector which the PSN address is PSN1) will contact with the start position of the user region of the recording layer L2 (i.e., the sector which the PSN address is PSN1+1). Because of using the recording method with the continuous PSN address, the problem that the conventional OTP addressing method uses an inverted recording address to saturate the recording field (wasting the addressing space) may be avoided. Thus the addressing technology of the exemplary embodiment may increase the layers of a disk according to the demands until the field achieves the saturation. Generally, the sector address with 24 bits can at least meet the addressing demand of four layers, the sector address with 25 bits can at least meet the addressing demand of 8 layers. The number of bits of the sector address can be increased according to users' demands to increase the addressing layer number.

Again, at the joint of different sectors in the same layer, the recording method with continuous PSN addresses is also used (as shown in the above-said). Thus, for the servo system, it can improve the performances of addressing tracks and jumping tracks by using the continuous address recording method. For example, when the recording layer performs the operation of jumping track, if the kinetic energy of jumping track of the optical pickup is too large, that is, the optical pickup jumps to the jump region and does not arrive at the predetermined user region, the servo system must perform the next jumping track to correct the position of the optical pickup. Because of the continuous address recording, the same jumping mechanism may be used to immediately perform the next short jumping track and return to the predetermined position of the user region. Correspondingly, if the joint of the user region and the jump region uses discontinuous address recording, the servo will perform another calculation and drive different jump mechanisms. Thus, it increases the burden of the system and decreases the efficiency of the system.

It is noted that the PSN address of the joint of the jump region and the user region is continuous, so it is easy for the servo system to read its data without additional addressing tracks and jumping tracks mechanism. At the same time, the differences among the region and others can be identified only by a simple judgment of the software. It is more important that the length of the jump region is not limited to the addressing method and may be adjustable according to users' demands to provide the additional recording space required by the user. For example, in the disk with dual layers, when the space of the user region is enough, the data of the user region of the recording layer L1 can be partially moved to the recording layer L2 to increase the space of the jump region of the recording layer L1. The addresses of the increased space of the jump region will not occupy the address recording field of the user region. Thus, the jump region is very fit for recording additional assistant data or other special application, such as defect manager applications, media authentication applications and the like.

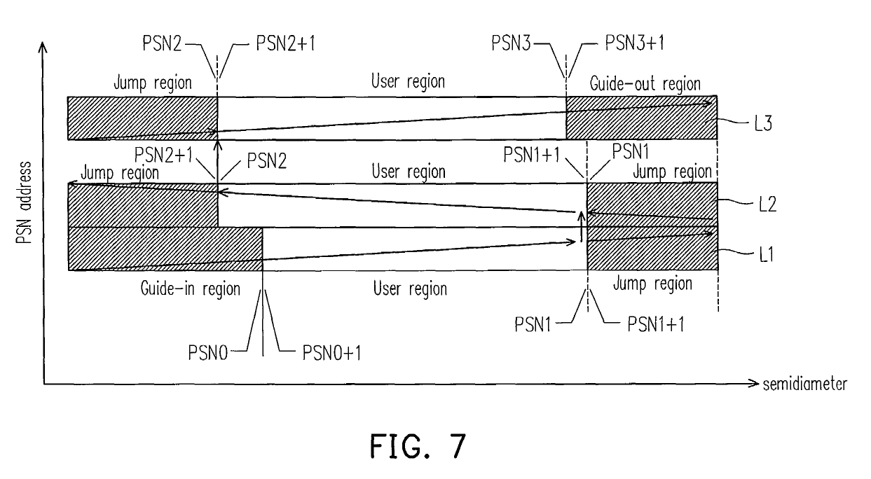

While the disk with single surface and dual layers is used as the exemplary embodiment of the present invention, those of ordinary skill in the art may obtain the disk with single surface and three layers, which shall be construed to be within the scope of the present invention. For example, FIG. 7 is a view illustrating an exemplary embodiment of the addressing of a disk with single surface and three layers according the present invention.

Referring to FIG. 7, the disk comprises the recording layer L1, L2 and L3. The recording layers L1, L2 and L3 respectively have data tracks formed of a plurality of sectors, each sector has a recording address (as shown in FIG. 6). The reading method of the recording layer L1 includes reading data is from its inner radius to its outer radius, the reading method of the recording layer L2 includes reading data is from its outer radius to its inner radius, and the reading method of the recording layer L3 is that reading data is from its inner radius to its outer radius. The first several sectors of the recording layer L1 are defined as the guide-in region, and the last several sectors of the recording layer L3 are defined as the guide-out region. In addition, the PSN addresses of the recording layers L1 and L3 increase from their inner radius to their outer radius, however, the PSN addresses of the recording layer L2 increase from its outer radius to its inner radius. In other exemplary embodiments, the reading methods of the recording layers L1 and L3 may be that reading data is from their outer radius to their inner radius, and the reading method of the recording layer L2 is that reading data is from its inner radius to its outer radius. According to the exemplary embodiment of the present invention, the PSN addresses of the recording layers L1 and L3 may increase from their outer radius to their inner radius, however, the PSN addresses of the recording layer L2 may increase from its inner radius to its outer radius.

Again referring to FIG. 7, if the PSN address of the last sector of the guide-in region is PSN0 (e.g., 01FFFFh), the continuous numbers from PSN0+1(e.g., 020000h) to PSN1 may be used as the PSN addresses of a plurality of data sectors in the user region. The above-said PSN1 is an integral number which is larger than the PSN0. Because the PSN address of the last data sector of the user region is PSN1, the PSN address of the jump region begins addressing at PSN1+1. That is, the addresses of all sectors of the guide-in region, the user region and the jump region are continuous.

The first several sectors of the recording layer L2 (the outer radius of the disk) are defined as a jump region, and the last several sectors of the recording layer L2 (the inner radius of the disk) are defined as the other jump region. The data sectors in the user regions may be used to record data. The addresses of all sectors in the recording layer L2 are also continuous. For example, if the PSN address of the first data sector of the user region in the recording layer L2 is PSN1+1, the PSN address of the jump region adjacent to the user region may begin addressing at PSN1 in the decreasing method from its inner radius to its outer radius. If the PSN address of the last data sector of the user region in the recording layer L2 is PSN2, the PSN address of the jump region adjacent to the user region may begin addressing at PSN2+1in the increasing method from its outer radius to its inner radius. The above-said PSN2 is an integral number which is larger than PSN1. It is noted that the PSN addresses of the data sectors of the user region in the recording layer L1 and the data sectors of the user region in the recording layer L2 are also continuous. For example, if the last PSN address of the data sector of the user region in the recording layer L1 is PSN1, the PSN addresses of all data sectors of the user region in the recording layer L2 may begin addressing at PSN1+1.

The first several sectors of the recording layer L3 (the inner radius of the disk) are defined as the jump region. The addresses of all sectors in the recording layer L2 are also continuous. For example, if the first PSN address of the first data sector of the user region in the recording layer L3 is PSN2+1, the PSN address the jump region adjacent to the user region may begin addressing at PSN2 in the decreasing method from its outer radius to its inner radius. If the PSN address of the last data sector of the user region in the recording layer L3 is PSN3, the PSN address of the guide-out region adjacent to the user region may begin addressing at PSN3+1in the increasing method from its inner radius to its outer radius. The above-said PSN3 is an integral number which is larger than PSN2. It is noted that the PSN addresses of the data sectors of the user region in the recording layer L2 and the data sectors of the user region in the recording layer L3 are also continuous. For example, if the PSN address of the last data sector of the user region in the recording layer L2 is PSN2, the PSN addresses of data sectors of the user region in the recording layer L3 begin addressing at PSN2+1.

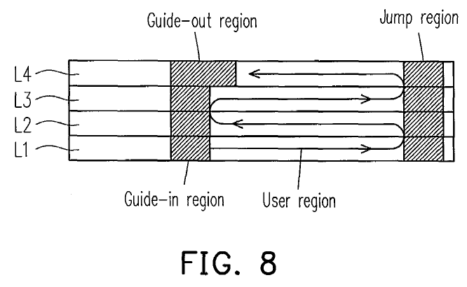

FIG. 8 is a view illustrating an exemplary embodiment of the addressing of a disk with single surface and four layers according the present invention. Referring to FIG. 8, the disk includes the recording layers L1, L2, L3 and L4. The recording layers L1, L2, L3 and L4 respectively have data tracks formed of a lot of sectors, each sector has the recording address (as shown in FIG. 6). The reading method for the disk is that reading data is from the inner radius of the recording layer L1 to the outer radius of the recording layer L1, and jumping to the recording layer L2 to read data from the outer radius of the recording layer L2 to the inner radius of the recording layer L2, then jumping to the recording layer L3 to read data from the inner radius of the recording layer L3 to the outer radius of the recording layer L3, and at last jumping to the recording layer L4 to read data from the outer radius of the recording layer L4 to the inner radius of the recording layer L4. The first several sectors of the recording layer L1 (the inner radius of the disk) are defined as the guide-in region, and the last several sectors of the recording layer L4 (the inner radius of the disk) are defined as the guide-out region. That is, in the exemplary embodiment, the odd recording layers read data from their inner radius to their outer radius, and the even recording layers read data from their outer radius to their inner radius. In addition, the PSN addresses of the odd layers increase from their inner radius to their outer radius, and the PSN addresses of the even layers increase from their outer radius to their inner radius.

According to the present invention, the PSN addresses of the odd recording layers also can increase from their outer radius to their inner radius, and the PSN addresses of the even recording layers may increase from their inner radius to their outer radius. In other exemplary embodiments, the recording layers L1 and L3 may read data from their outer radius to their inner radius, and the recording layers L2 and L4 may read data from their inner radius to their outer radius. That is, according to the present invention, the odd recording layers of the disk can read data from their outer radius to their inner radius, and the even recording layers may read data from their inner radius to their outer radius.

Again referring to FIG. 8, the addresses of all sectors of the recording layer L1, L2, L3 and L4 are continuous. The PSN addresses of the data sectors of the user region in the recording layer L1 and the PSN addresses of the data sectors of the user region in the recording layer L2 are all continuous. The PSN addresses of the data sectors of the user region in the recording layer L3 and the PSN addresses of the data sectors of the user region in the recording layer L4 are also continuous. The detailed addressing methods of FIG. 8 can be understood in reference with the above-said exemplary embodiments. The addressing method of the present invention will be adapted for a multi-layer optical disk by those of ordinary skill in the art, which also be construed to be within the scope of the present invention.

In short, the continuous addressing method for the multi-layer optical disk comprises the following steps. First, a multi-layer optical disk including a plurality of recording layers is provided. Each recording layer has a plurality of sectors, wherein each sector has fields, such as a PSN address, a region type and the like. Next, the region type field of the each sector is defined to identify that the region is a guide-in region, a guide-out region, a user region or a jump region such that the sector can be divided into at least a user region and at least a controlling region (may be a guide-in region, guide-out region or a jump region) by defining the above-said region type field. Next, the field of the PSN addresses of sectors in the N^{th} recording layer is defined such that the PSN addresses of the N^{th} recording layer are continuous. Next, the field of the PSN addresses of sectors in the (N+1)^{th} recording layer is defined such that the PSN addresses of the (N+1)^{th} recording layer are continuous. Wherein the PSN addresses of the user region of the N^{th} recording layer and the PSN addresses of the user region of the (N+1)^{th} recording layer are also continuous. Wherein the PSN address may be replaced by anyone type of basic address unit. For example, three data regions may be integrated into one basic address unit, if the basic address unit has continuous addressing relationship, the unit can meet the demands of the present invention.

The above exemplary embodiments entail the PSN addresses are continuous. If only the last 8 bits of the PSN address is considered, and the user region of each layer has 6 data sectors, so the PSN addresses of the 6 sectors of the user region in the N^{th} recording layer may be respectively defined as [0000 000b], [0000 0001b], [0000 0010b], [0000 0011b], [0000 0100b] and [0000 0101b], then the PSN addresses of the 6 sectors of the user region in the (N+1)^{th} recording layer may be respectively defined as [0110 0110b], [0000 0111b], [0000 1000b], [0000 1001b], [0000 1010b] and [0000 1011b]. Thus, the PSN addresses of the user region of the N^{th} recording layer and the PSN addresses of the user region of the (N+1)^{th} recording layer are also continuous.

Wherein the PSN address may be replaced by anyone type of basic address unit. For example, in the disk, every i adjoining sectors will be integrated into a set of sectors (wherein the i represents an integral number), there are values which is not used between the PSN address of the last sector in the current set of sectors and the PSN address of the first sector of the next set of sectors. It is noted that the method with the PSN addresses being continuous according to the present invention is not limited to the above-said method. All the fields of the PSN addresses of the sectors in various recording layers are continuously defined by single rule. That is, the defined PSN addresses are continuous which are within the scope of the present invention. According to the above-said exemplary embodiment, if every 3 (i.e., i=3) sectors are integrated into one basic unit, the PSN addresses of the 6 sectors of the user region in the N^{th} recording layer may be respectively defined as [0000 000b], [0000 0001b], [0000 0011b], [0000 0100b], [0000 0101b] and [0000 0110b] (there is the number value [0000 0011b] which is not be used between [0000 0010b] and [0000 0100b]), then the PSN addresses of the 6 sectors of the user region in the (N+1)^{th} recording layer may be respectively defined as [0000 1000b], [0000 1001b], [0000 1010b], [00001 1100b], [0000 1101b] and [0000 1110b] (there is the number value [0000 1011b] which is not be used between [0000 1010b] and [0000 1100b]). While the defined PSN addresses in decimal form may be 0, 1, 2, 4, 5, 6, 8, 9, 10, 12, 13, 14 . . . , the numbers are not continuous, however, all the fields of the PSN addresses of the sectors in various recording layers are continuously defined by single rule. That is, the defined PSN addresses are continuous which are in the scope of the present invention.

In addition, in the above exemplary embodiment, every 3 sectors will be integrated into one set of sectors (i.e., the user region of each layer only has 2 sets of sectors), thus the PSN addresses of the 2 sectors of the user region in the N^{th} recording layer respectively are [0000 00xxb] and [0000 01xxb], and the PSN addresses of the 2 sectors of the user region in the (N+1)^{th} recording layer respectively are [0000 10xxb] and [0000 11xxb]. Thus, the PSN addresses of the user region of the N^{th} recording layer and the PSN addresses of the user region of the (N+1)^{th} recording layer are also continuous. The method of the present invention records data using continuous PSN addresses. The PSN addresses of each layer may be converted to the corresponding PSN addresses of the recording layer L1 through a simply converting calculation. For example, as shown in FIG. 5, in the disk with single surface and dual layers, if defining the sector X of the recording layer L2, corresponding formula is:

X′=PSN1−[X−PSN1]

### That is:

X′=2*PSN1−X

Wherein the X′ represents the corresponding PSN address of the recording layer L1 after a converting calculation. The X′ provides the relative position of the servo system relative to the disk and will be helpful for jumping tracks and addressing.

For a multi-layer disk, the PSN addresses of each layer may also be converted to the corresponding PSN addresses of the recording layer L1. At first it is determined which recording layer the PSN addresses are in, and the converting formula is to be selected, then the converting calculation can be performed. The converting formula will change in different layers and can judge and perform the converting calculation according to the calculation performance of software. While the performance of the converting address is little worse than that of the OTP addressing method, however, the operation speed is very quick by present technology, the above difference become very small. It is more important that the problem about the addressing of a multi-layer disk can be solved.

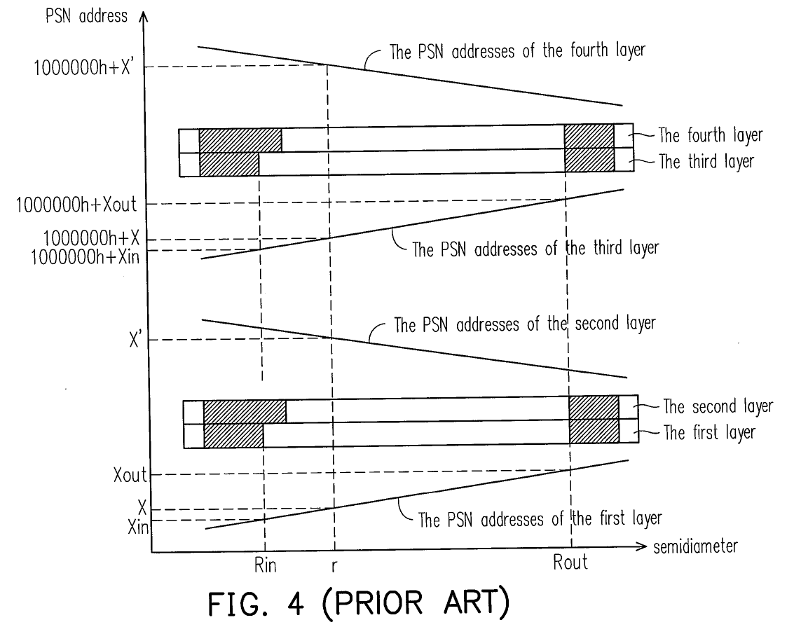

In short, the PTP addressing method can not record continuous data and can not efficiently record multi-layer disks, so a new addressing method of a disk must be designed. U.S. Pat. No. 5,881,032 mainly introduces an addressing method, including the design for the PSN address and the operation method of the servo system and the like. But the addressing method of the above U.S. patent is only adapted for the disk with dual layers. If it is adapted for the disk with two more layers, another ID field must be added (as shown in FIG. 4). The more layers in the disk, the more length the ID field will be. So it increases complexity and wastes recording fields. The present invention and the above-said exemplary embodiment provide a new recording method for the PSN address. The new method is that addressing is performed among various regions by continuous PSN addresses and the PSN addresses of the user region of the two adjoining layers are also continuous (inverted PSN address not being used). Because the PSN addresses are continuous, it is easy to achieve the addressing of multi-layer disks, the longer the field of the PSN address, the more the number of the recording layers will be. In addition, in different regions of the same layer (e.g., for DVD-ROM, a recording layer L1 may include a lead-in region, a middle region and a data region), the jump region (or the middle region in the DVD-ROM) will not occupy the addressing space of the user region (or the data region in the DVD-ROM) using the recording method for continuous PSN address. Thus, the jump region may be used to additionally record data or for other applications. The servo system also can obtain the important address information by a simple formula to read data. The present invention may record continuous data and can solve the problem about addressing of multi-layer disks. The addressing technology may be adapted for other disks, such as HD-DVD or Blu-ray disc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A continuous addressing multi-layer optical disk, comprising:
a plurality of recording layers, each recording layer respectively having a plurality of sectors, wherein the sectors are divided into at least a user region and at least a control region, wherein each sector has a PSN address and a region type, the PSN addresses of the sectors in an N^{th} recording layer are continuous, the PSN addresses of the sectors in an (N+1)^{th} recording layer are continuous, and the PSN addresses of the user region in the N^{th} and (N+1)^{th} recording layers are continuous.

2. The continuous addressing multi-layer optical disk according to claim 1, wherein the control regions include guide-in regions, guide-out regions and jump regions.

3. The continuous addressing multi-layer optical disk according to claim 1, wherein odd numbered recording layers of the multi-layer optical disk read data from inner radius to outer radius, and even numbered recording layers of the multi-layer optical disk read data from outer radius to inner radius.

4. The continuous addressing multi-layer optical disk according to claim 1, wherein odd numbered recording layers of the multi-layer optical disk read data from outer radius to the inner radius, and even numbered recording layers of the multi-layer optical disk read data from inner radius to outer radius.

5. The continuous addressing multi-layer optical disk according to claim 1, wherein a sector to which the region type belongs to is defined as a guide-in region, a guide-out region, a user region or a jump region by the region type of each one of the sectors.

6. The continuous addressing multi-layer optical disk according to claim 1, wherein, in the sectors, every i adjoining sectors are integrated into a set of sectors, and there are address values which are not used between the PSN address value of the last sector of the current set of sectors and the PSN address value of the first sector of the next set of sectors, wherein i is integer.

7. A continuous addressing method, comprising:
providing a multi-layer optical disk including a plurality of recording layers, each recording layer respectively having a plurality of sectors, wherein each sector has a PSN address and a region type;
dividing the sectors into at least a user region and at least a control region by defining the region type;
defining the PSN addresses of the sectors of an N^{th} recording layer in the recording layers such that the PSN addresses of the sectors of the N^{th} recording layer are continuous; and
defining the PSN addresses of the sectors of an (N+1)^{th} recording layer in the recording layers such that the PSN addresses of the sectors of the (N+1)^{th} recording layer are continuous;
wherein the PSN addresses of the user region of the N^{th} and (N+1)^{th} recording layers are continuous.

8. The continuous addressing method according to claim 7, wherein the control regions include guide-in regions, guide-out regions and jump regions.

9. The continuous addressing method according to claim 7, wherein the PSN addresses of the sectors of odd numbered recording layers of the multi-layer optical disk increase from inner radius to outer radius, and the PSN addresses of the sectors of even numbered recording layers of the multi-layer optical disk increase from outer radius to inner radius.

10. The continuous addressing method according to claim 7, wherein the PSN addresses of the sectors of odd numbered recording layers of the multi-layer optical disk increase from outer radius to inner radius, and the PSN addresses of the sectors of even numbered recording layers of the multi-layer optical disk increase from the inner radius to the outside radius.

11. The continuous addressing method according to claim 7, further comprising: defining the region type of each one of the sectors to identify that a sector to which the region type belongs to is a guide-in region, a guide-out region, a user region or a jump region.

12. The continuous addressing method according to claim 7, wherein, in the sectors, every i adjoining sectors are integrated into a set of sectors, and there are address values which are not used between the PSN address value of the last sector of the current set of sectors and the PSN address value of the first sector of the next set of sectors.
